(19) United States
(12) Patent Application Publication
(10) Pub. No.: US 2022/0388870 A1
(43) Pub. Date: Dec. 8, 2022

(54) FLUID COLLECTION SYSTEM

(71) Applicant: MEGA DRAIN GP LLC, Austin, TX (US)

(72) Inventors: Robert E. Kibel, Springfield, IL (US); James C. Cowden, Jr., Austin, TX (US)

(21) Appl. No.: 17/830,429

(22) Filed: Jun. 2, 2022

Related U.S. Application Data
(60) Provisional application No. 63/196,016, filed on Jun. 2, 2021.
(60) Provisional application No. 63/253,773, filed on Oct. 8, 2021.
(60) Provisional application No. 63/326,716, filed on Apr. 1, 2022.

(51) Int. Cl. C02F 1/00; C02F 7/00; E03B 1/02

(52) U.S. Cl. CPC C02F 1/004; C02F 7/00; E03B 1/02; C02F 2103/02

(57) ABSTRACT

Embodiments of the present disclosure are directed towards a fluid collection system, method, and use. The system included herein provides a liner at least partially disposed around a cavity and a geocellular module configured to provide structural support to the cavity and to receive fluid therein. The system further comprises a filter at least partially disposed around the geocellular module and a cover at least partially disposed above the geocellular module to provide structural support to the cavity.

### CROSS-REFERENCE TO RELATED APPLICATIONS

This application is related to U.S. provisional applications having application Nos. 63/196,016, filed on Jun. 2, 2021, 63/253,773, filed on Oct. 8, 2021, and 63/326,716 filed on Apr. 1, 2022, the entire contents of which are incorporated by reference in their entirety.

### BACKGROUND OF THE INVENTION

### Field of the Invention (Technical Field)

The present invention relates to fluid management systems regularly employed to assist various construction, industrial, and transportation activities to handle on-site water issues, perform moisture reduction, etc.

### BACKGROUND

Commercial and industrial processes require extensive use of fluid, most commonly aqueous solutions, to process, wash, gather, and/or separate materials. Among these processes are those related to mining, asphalt and cement production, shipping, agriculture, and oil and gas production. The cost of these processes are affected by the availability and price of water. Reclamation of fluid used in these processes, for example, acidic solution from bioleached mineral tailings, is critical for economically sustainable operations. The increasing scarcity of water due to climate change and environmental regulation creates a need for systems to collect fluid without extensive use of powered components or expensive reagents.

What is needed is a system to passively collect fluid from commercial and industrial processes to offset the increased cost of water. The passive collection should be easily and economically installed at a site to efficiently collect fluid over a prolonged period of time.

### BRIEF SUMMARY OF THE INVENTION

The invention of the present disclosure relates to a system and apparatus for collecting fluid, the system comprising: a geocellular module; a liner below and at least partially disposed around said geocellular module; a filter disposed above said geocellular module; a cover disposed above said geocellular module; and said system disposed at a gradient.

In one embodiment, the system further comprises a drainage board. In another embodiment, the system further comprises an internal washing system. In another embodiment, the system further comprises a subdrain. In another embodiment, the system further comprises a separation tank. In another embodiment, the geocellular module comprises a non-reactive material. In another embodiment, the liner comprises a geomembrane liner. In another embodiment, the system further comprises a lift station. In another embodiment, the system further comprises an aerator. In another embodiment, the cover is modular. In another embodiment, the system comprises a void space of about 20% to about 97%. In another embodiment, the system further comprises at least one dewatering bag at least partially disposed above the geocellular module. In another embodiment, the dewatering bag comprises a coating. In another embodiment, the dewatering bag comprises a flocculant.

The invention of the present disclosure also relates to a method for collecting fluid, the method comprising: passing a fluid through a cover; receiving the fluid into a cavity; contacting the fluid with a geocellular membrane; contacting the fluid with a geomembrane liner; flowing the fluid along a gradient; and collecting the fluid. In one embodiment, the method further comprises passing the fluid into a separation tank. In another embodiment, the method further comprises aerating the fluid.

The invention of the present disclosure also relates to a tailings system comprising: a fluid collection system comprising: a geocellular module; a liner below and at least partially disposed around said module; a filter disposed above the geocellular module; a cover disposed above the geocellular module; and the system disposed at a gradient; at least one dewatering bag; said at least one dewatering bag at least partially disposed above the fluid collection system; and a conduit in communication with the at least one dewatering bag. In one embodiment, the at least one dewatering bag comprises a coating. In another embodiment, the system further comprises a plurality of dewatering bags arranged in a stacked or pyramidal configuration.

Embodiments of the present disclosure are directed to fluid collection using the system of the present invention. The system provides numerous advantages over existing technologies. Some of these may include, but are not limited to, consistent dewatering capture and reuse; tailing pond water management through dewatering and enhanced evaporation; evaporation elimination of below ground stored reuse water; polymer mix additive reduction due to water reuse; filtering of drained and/or decanted capture water; management of total suspended solids; water lifecycle management in a mine; filtering of fine gold and fine silver and other precious metals and base metals in heap leach mining; carbon output reduction; and increased energy efficiency for fluid collection and processing. The system may be passive and does not consume energy to function for dewatering or storage. The system may be durable in that the components are non-reactive to the product being drained above or the fluid stored below or processed. The system may comprise structural loading capabilities in excess of 200,000 lbs., so that large loaders and dozers are able to operate on top of the system without collapsing. The system may operate at a reduced energy consumption cost, with less electricity or natural gas used to recover fluid. The system offers a faster drying time which reduces the need for larger stockpiles for inventory and may have a life expectancy of 20 years. The system may operate in multiple sectors, and may be implemented for mining, agriculture, and industrial applications. These mining, agriculture, and industrial applications include, but are not limited to, coal, coal ash, fly ash, iron ore, diatomaceous earth, frac sand, glass sand, silica sand, potash production, salt, oil sands, metals, and minerals, including base metals and precious metals, including but not limited to, copper, gold, silver, platinum, rare earth metals, graphite, lithium, cobalt, nickel, manganese, and cadmium, landfill leachate pit management, frac fluid processing, mining tailings, oil sands tailings, other tailings, and electronic waste and battery recycling.

As will be discussed in greater detail below, embodiments of the present disclosure comprise a fluid collection system. The system included herein may comprise a liner and one or more geocellular modules. The liner may comprise a geomembrane liner and surround a region to form a cavity. The cavity may comprise an excavated area. A geocellular module may be at least partially disposed within the cavity. The geomembrane liner may be configured to provide structural support to maintain the cavity. The liner may form a first layer at least partially disposed around the cavity. The geocellular module may also be configured to provide structural support within the cavity. The cavity may receive a fluid. The system may further comprise a filter. The filter may comprise a fabric. The system may also comprise a cover. The cover may be perforated, interconnected, modular, interlocking, or a combination thereof. The cover may be at least partially disposed above the geocellular module and may provide structural support to maintain the cavity.

The system may comprise a drainage board. The drainage board may be at least partially disposed between the cover and the geocellular module. The drainage board may comprise a polymer material, including, but not limited to, a plastic. The system may also comprise a drainage sheet. The drainage sheet may comprise a polymer material, including, but not limited to, a plastic. The drainage sheet may be in contact with the liner. The drainage sheet may form a second layer around the cavity where the first layer comprising the liner is at least partially disposed within the second layer comprising the drainage sheet. The drainage sheet may form a part of a strip drain. The system may further comprise a separation tank configured to receive a fluid, e.g., effluent, from the geocellular module. The separation tank may separate a fluid into aqueous and hydrophobic fluids. The system may also comprise a lift station. The lift station may be configured to receive an output from the separation tank. The lift station may comprise fiberglass, concrete, metal, plastic, lumber, or a combination thereof, or other suitable materials. The system may also comprise a heating apparatus configured to provide heat to the geocellular module. The heating apparatus may be flameless. The system may comprise an access unit. The access unit may be adjacent to the geocellular module. The access unit may allow for visual inspection of the geocellular module, liner, cavity, cover, or a combination thereof. The access unit may comprise an above ground level access point and may be entered through the above ground level access point. The access unit may comprise an extension shaft. The system may also comprise a subdrain. The subdrain may be at least partially disposed beneath the geocellular module and liner.

In another implementation/embodiment, a drainage method is provided. The method may comprise contacting a quantity of fluid with a cover, wherein the cover is at least partially disposed over a geocellular module. The cover may provide structural support to the cavity. The method may further comprise filtering at least a portion of the fluid through the cover and/or the filter. The method may also comprise the cavity receiving filtered fluid and contacting the fluid with the geocellular module at least partially disposed within the cavity.

One or more of the following features may be included. The method may comprise collecting fluid using a subdrain. The subdrain may be at least partially disposed beneath the geocellular module and the liner. The method may further comprise receiving fluid, e.g., effluent, from the geocellular module at a separation tank. The method may also comprise receiving an output from the separation tank at a lift station. The method may further comprise providing heat via one or more connection shafts. The method may also comprise performing video or other inspection of the geocellular module via the one or more connection shafts. The method may further comprise transporting fluid from the lift station to a pond or storage facility. The method may also comprise providing an output from the separation tank to a total suspended solids (“TSS”) collection area for aeration. The method may further comprise connecting a water source to a pipe that is configured to connect to an internal washing system at least partially disposed within the cavity. The method may also comprise transporting fluid, e.g., effluent, from the geocellular module to a wash plant.

The details of one or more example embodiments or implementations of the invention are set forth in the accompanying drawings and the description below. Other possible example features and/or possible example advantages will become apparent from the description and the drawings. Some implementations may not have those possible example features and/or possible example advantages, and such possible example features and/or possible example advantages may not necessarily be required of some implementations.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a diagram showing an embodiment of a fluid collection system;

FIG. 2 is a diagram showing an embodiment of a fluid collection system disposed beneath material and in communication with a separation tank;

FIG. 3 is a diagram showing an embodiment of a fluid collection system in communication with a separation tank and a heater;

FIG. 4 is a diagram showing an embodiment of a fluid collection system in communication with a separation tank and a lift station;

FIG. 5 is a diagram showing processing steps for fluid collected with a fluid collection system;

FIG. 6 is a diagram showing an embodiment of a fluid collection system in a drain field;

FIG. 7 is a diagram showing an embodiment of a fluid collection system in a drain field;

FIG. 8 is a diagram showing an embodiment of a fluid collection system with a stacked access unit;

FIG. 9 is a diagram showing an embodiment of a fluid collection system in communication with fluid processing modules;

FIG. 10 is a diagram showing an embodiment of a fluid storage structure;

FIG. 11 illustrates a diagram showing the collection of fluid from a mining or mineral processing operation using the system of the present invention;

FIG. 12 illustrates a diagram showing the collection of fluid from mineral tailings using the system of the present invention;

FIG. 13 illustrates a diagram showing the formation of a dry stack dam and the collection of fluid using the system of the present invention;

FIG. 14 illustrates a diagram showing the collection of fluid from aggregate material using the system of the present invention; and

FIG. 15 illustrates a diagram showing flocculant disposed within a dewatering bag.

Like reference symbols in the various drawings may indicate like elements.

### DETAILED DESCRIPTION OF THE INVENTION

The discussion below is directed to certain embodiments/implementations of the present invention. It is to be understood that the discussion below is only for the purpose of enabling a person with ordinary skill in the art to make and use any subject matter defined now or later by the patent claims found in any issued patent related to herein.

It is specifically intended that the combinations of features not be limited to the embodiments, implementations, and illustrations contained herein, but comprise modified forms of those embodiments and implementations including portions and combinations thereof. It should be appreciated that in the development of any such actual embodiment or implementation, as in any engineering project, numerous implementation-specific decisions must be made to achieve specific goals, such as compliance with system-related and business-related constraints, which may vary from one embodiment or implementation to another. Moreover, it should be appreciated that such a development effort might be complex and time consuming, but would nevertheless be a routine undertaking of fabrication and manufacture for those of ordinary skill having the benefit of this disclosure. Nothing in this application is considered critical or essential to the claimed invention unless explicitly indicated as being “critical” or “essential.”

It will also be understood that, although the terms first, second, etc., may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

The term “fluid” is defined in the claims and specification as any liquid or partially liquid material. The term fluid includes, but is not limited to, one or more aqueous solutions, pure liquids, mixtures, homogenous mixtures, heterogenous mixtures, non-Newtonian fluids, Newtonian fluids, sludges, organic solvents, gels, pastes, emulsions, slurries, suspended solids, or a combination thereof.

The term “tank” is defined in the claims and specification as a vessel, chamber, container, receptable, and/or other object capable of containing a fluid. The term shall encompass any vessel, chamber, container, receptable, and/or other object of suitable scale or material. For example, it may include a large acid-resistant tank for mining applications.

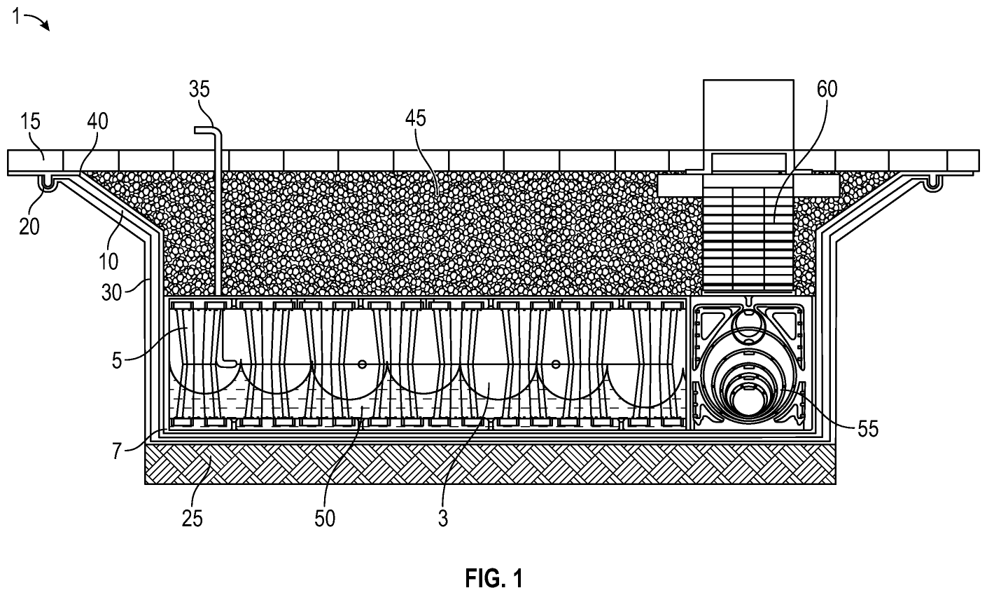

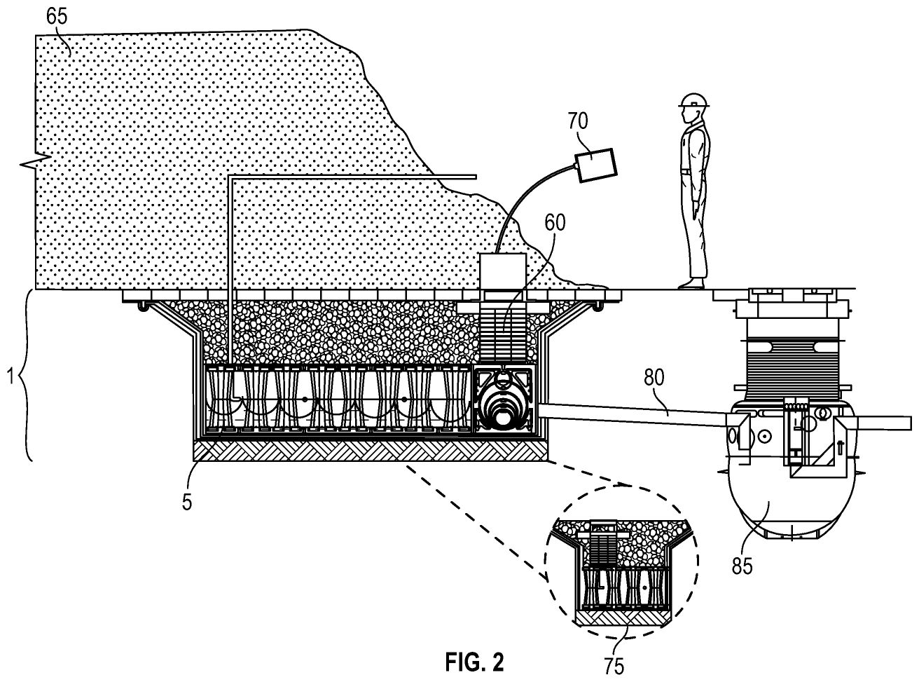

Turning now to the figures, which show embodiments of the systems of the invention, FIGS. 1-2 show fluid collection system 1. Geocellular module 5 creates void space 3. Fluid collection system 1 may comprise a plurality of geocellular modules 5 to increase void space 3. Fill material 45 may be at least partially disposed above geocellular module 5. Void space 3 may receive fluid 50. Fluid 50 may be in contact with geocellular module 5 and/or liner 30. Fluid-containing material 65 may be at least partially disposed above geocellular module 5 and/or liner 30. Insert 75 depicts system 1 before fluid-containing material 65 is disposed above geocellular module 5 and/or liner 30.

Cover 15 may comprise a polymer, a metal, a rubber, a plastic, or a combination thereof. Cover 15 may comprise a deck, modular pieces, interconnected portions, or a combination thereof. Cover 15 may also be perforated, porous, channeled, or a combination thereof. Cover 15 may comprise a Marston mat, perforated deck, or a combination thereof. Cover 15 may be at least partially disposed above liner 30 and geocellular module 5. Filter 7 may be at least partially disposed around and/or above geocellular module 5. Filter 7 may remove particulates or solids from fluid prior to fluid entering void space 3 and contacting geocellular module 5 of system 1. Filter 7 may comprise a fabric. The fabric may be monofilament, woven, or a combination thereof. Filter 7 may comprise pores. The pores may be adjusted based on the fluid to be filtered. Filter 7 may be site-specific such that the fluid entering void space 3 and contacting geocellular module 5 may be assessed prior to system 1 installation to determine the optimum filter 7 pore size for filtering the fluid. System 1 may comprise an internal washing system 35. Internal washing system 35 may comprise spray nozzles and may apply water, liquid, or an aqueous solution to clean and/or rinse geocellular module 5.

System 1 may comprise one or more layers of liner 30. Liner 30 may comprise a geomembrane liner. Liner 30 may be at least partially disposed around fabric layer 40. Fabric layer 40 may comprise a geotextile material. The geotextile may be woven, non-woven, or a combination thereof. Liner 30 may comprise polyester, glass, bitumen, oxidized bitumen, sand, high-density polyethylene, low-density polyethylene, polyvinyl chloride, polypropylene, chlorosulfonated polyethylene, ethylene propylene diene terpolymer, or a combination thereof. Optionally, fabric layer 40 may be at least partially disposed around liner 30. Liner 30 and fabric layer 40 are preferably at least partially disposed beneath cover 15. Optionally, liner 30 and/or fabric layer 40 are held in place by trench anchor 20.

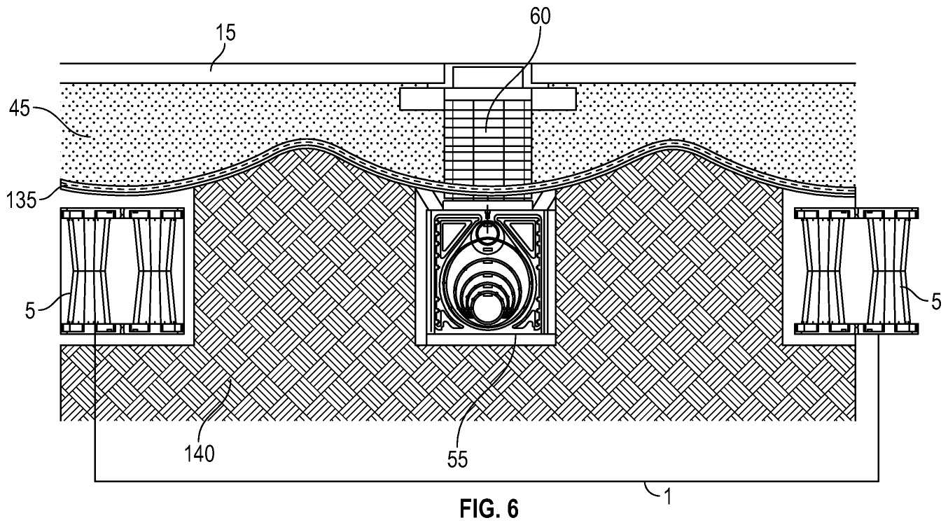

System 1 may also comprise access unit 60 comprising access hatch 55 (see FIG. 6). System 1 may comprise at least one access unit 60 and may comprise a plurality of access units 60. Access unit 60 may be disposed adjacent geocellular module 5. Access unit 60 may allow for visual inspection, vacuum truck access, and remote camera access of the geocellular module and/or plurality of geocellular modules. In some embodiments, the visual inspection may be performed using one or more camera system 70 in communication with a remote camera screen. Access unit 60 provides a warm air supply riser connection and may provide access above ground level using an extension shaft, above ground access point, or any suitable approach.

In operation, a quantity of fluid may be received by cover 15. System 1 may filter a portion of the fluid through cover 15 and filter 7. The filtered liquid may be received by void space 3 and be in contact with geocellular module 5.

System 1 may also comprise a drainage sheet at least partially disposed beneath liner 30 as part of subdrain/strip drain 25. Subdrain/strip drain 25 may comprise, but not be limited to, polyvinyl ethylene, a geotextile, or a combination thereof. Subdrain/strip drain 25 may comprise, but not be limited to, a tubular or flattened tubular fluid conveyor. Subdrain/strip drain 25 may drain and direct fluid by capillary action, osmotic pressure, air pressure, active or passive pumping, or a combination thereof. Subdrain/strip drain 25 may be at least partially disposed beneath geocellular module 5 and/or liner 30. In some embodiments, system 1 may comprise a drainage board at least partially disposed between cover 15 and geocellular module 5.

In some embodiments, system 1 may further comprise separation tank 85. Separation tank 85 may be configured to receive fluid from system 1 via conduit 80. Conduit 80 may comprise, but shall not be limited to, a pipe, channel, tube, or any other means of conveying fluid. Conduit 80 may be, but shall not be limited to, about 6″, about 8″, or about 12″ in diameter and may comprise, but shall not be limited to, a high-density polyethylene, metal, wood, plastic, rubber, glass, fiberglass or any other material suitable for conveying fluid. Separation tank 85 may be configured to separate fluid components. Separation tank 85 may separate a hydrophobic and/or hydrophilic component, a salt, an ion, a gas, a solid, a contaminant, a chemical or a combination thereof from the remainder of the fluid. Separation tank 85 may provide an output via another conduit, which may be similar to conduit 80 described above. A solid perforated cover may be provided for ventilation and access to separation tank 85.

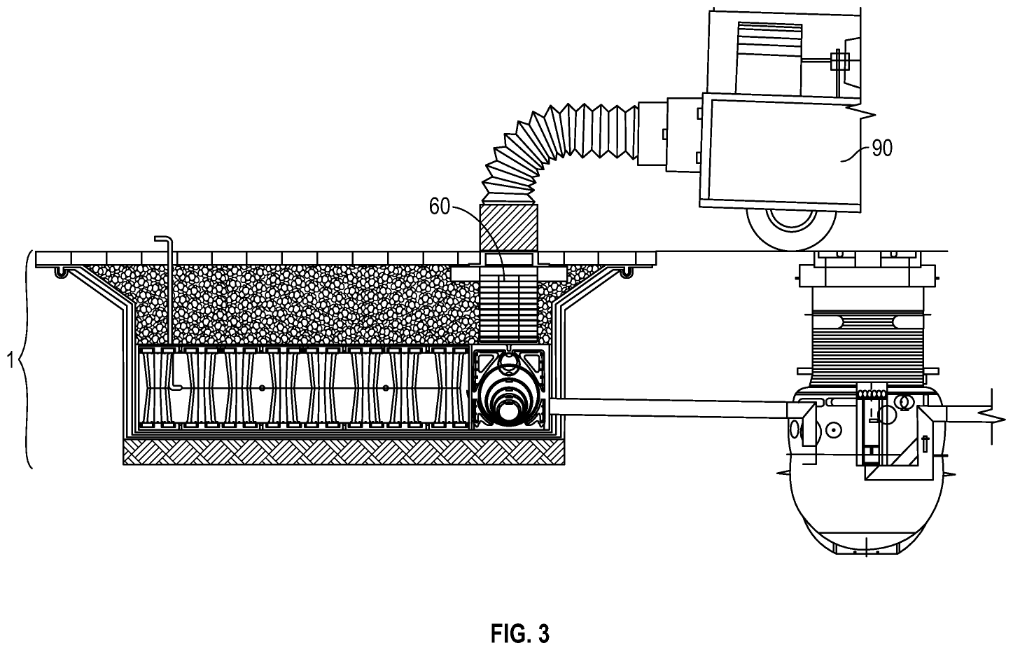

Referring now to FIG. 3, an embodiment showing system 1 comprising a heater 90 is provided. Heater 90 may be a flameless heater. Heater 90 may be removably connected to access unit 60 using a connector and configured to provide heat to a geocellular module. In some embodiments, heater 90 may be mounted on a trailer and used as a mobile unit.

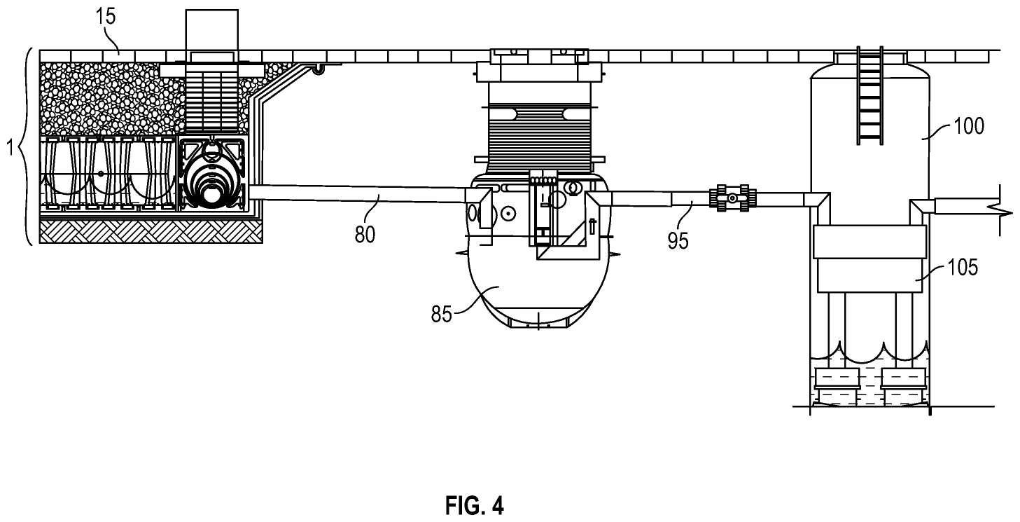

Referring now to FIG. 4, an embodiment of system 1 may comprise lift station 100 configured to receive an output from separation tank 85 via conduit 95. Separation tank 85 may be in communication with system 1 via conduit 80. Lift station 100 may also comprise any suitable material including, but not limited to, fiberglass, wood concrete, metal, plastic, rubber, or a combination thereof. Lift station 100 may comprise lift cover, which may be constructed out of any suitable material including, but not limited to, fiberglass, wood, concrete, metal, plastic, rubber, or a combination thereof. Lift station 100 may also comprise an access ladder. Lift station 100 may comprise one or more pumps 105, which may be at least partially disposed within lift station 100. A conduit may provide a mechanism by which fluid may exit lift station 100. A valve may be located between liquid separation tank 85 and lift station 100. The valve may be in-line and may comprise a polymer. Cover 15 may be disposed above separation tank 85 and/or lift station 100.

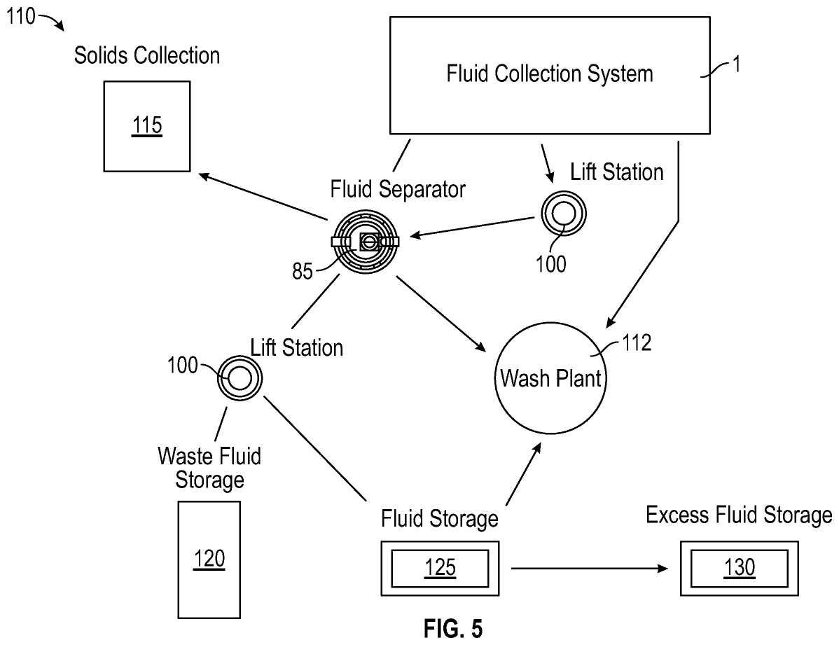

Referring now to FIG. 5, an embodiment showing system 110 is provided. In some embodiments, the systems included herein may be configured to convey fluid from the lift station to a pond and/or storage facility. The system may provide an output from the separation tank to a total suspended solids (“TSS”) collection area for aeration. Fluid collection system 1 may convey fluid to and/or be in communication with separation tank 85 and/or lift station 100. Separation tank 85 may comprise a fluid separator and may be in communication with solids collection tank 115, a second lift station 100, wash plant 112, or a combination thereof. Lift station 100 may be in communication with waste fluid storage tank 120 and/or fluid storage tank 125. Fluid storage tank may be in communication with wash plant 112 and/or excess fluid storage tank 130. System 110 may comprise one or more separation tank 85, lift station 100, collection tank 115, waste fluid storage tank 120, fluid storage tank 125, and/or excess fluid storage tank 130.

Referring now to FIG. 6, an embodiment showing system 1 disposed within an augmented drain field is provided. In this embodiment, drainage sheet 135 is at least partially disposed above geocellular module 5 and/or at least partially disposed below cover 15. Fill material 45 may be at least partially disposed over drainage sheet 135. Access unit 60 may be at least partially disposed within fill material 45, above drainage sheet 135, and/or below cover 15. Drainage sheet 135 may comprise polyvinyl ethylene, a geotextile, or a combination thereof. Drainage sheet 135 may comprise a tubular or flattened tubular fluid conveyor. Drainage sheet 135 may drain and/or direct fluid by capillary action, osmotic pressure, air pressure, active or passive pumping, or a combination thereof. Optionally, subsurface material 140 may be disposed between access hatch 55 and geocellular membrane 5.

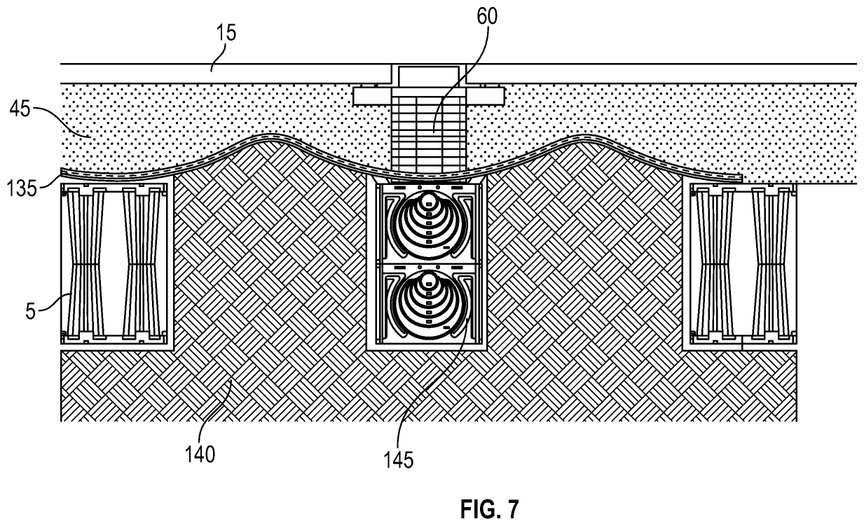

FIG. 7 shows an embodiment comprising system 1 disposed within an augmented drain field. In this embodiment, drainage sheet 135 may comprise filter 7 and a confinement grid. Drainage sheet 135 may be at least partially disposed above geocellular module 5. Access unit 60 may be at least partially disposed within fill material 45, above drainage sheet 135, and/or below cover 15. The confinement grid may comprise, but is not limited to, polypropylene, carbonaceous matter, resin, or a combination thereof. Filter 7 may comprise a pore size specific to the fluid being filtered. Filter 7 may comprise, but is not limited to, a fabric and the fabric may be monofilament. Fill material 45 may be at least partially disposed above drainage sheet 135. Optionally, subsurface material 140 may be disposed between stacked hatch 145 and geocellular membrane 5. Stacked access hatch 145 may comprise a plurality of access hatch 55.

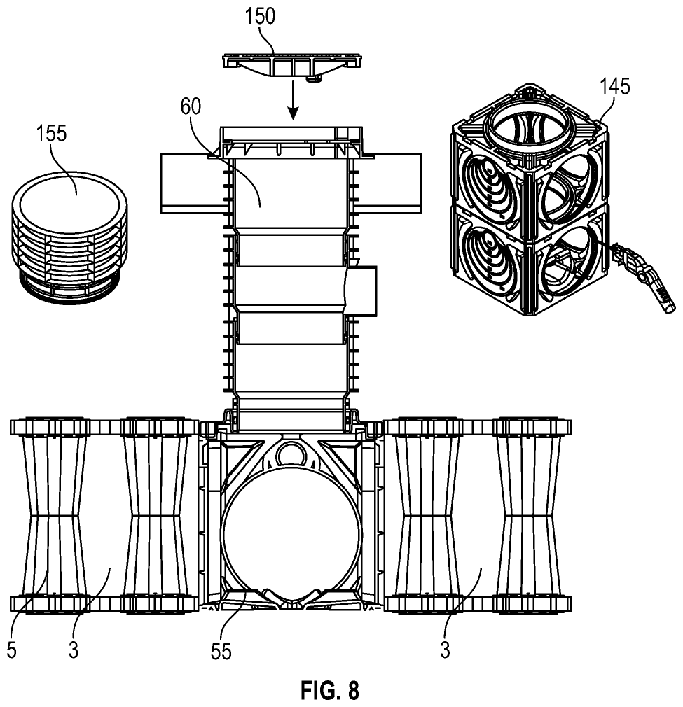

FIG. 8 shows an embodiment with plurality of geocellular modules 5 and access unit 60 having extension shaft 155. Extension shaft 155 may be attached to access unit 60 by connector 150. In some embodiments, access unit 60 may comprise knockouts for pipe compatibility. Extension shaft 155 may be cut/stacked to match any desired height. Extension shaft 155 may comprise a heater. The heater may be a flameless heater. Extension shaft 155 also allows for video inspection of plurality of geocellular modules 5, one or more access hatch 55 or stack access hatch 145 and/or any portion of the cavity and/or void space 3.

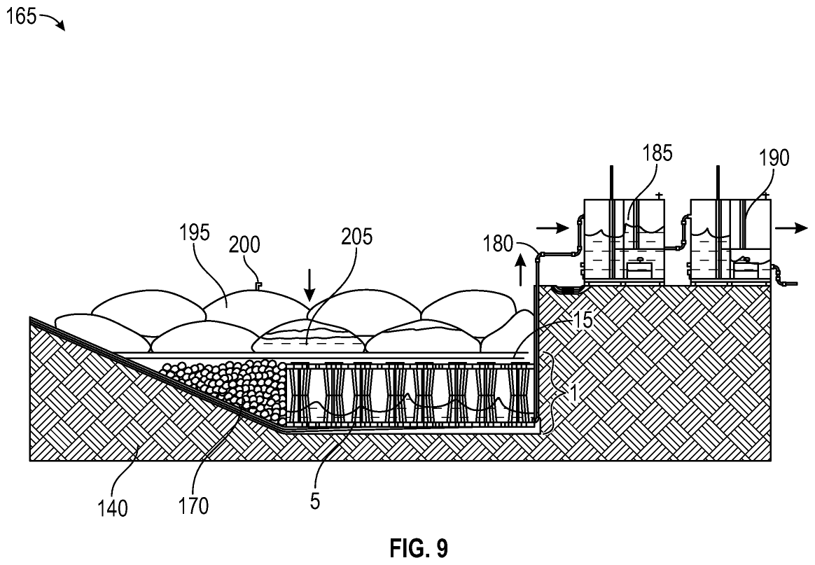

FIG. 9 shows fluid collection and processing system 165. Fluid collection system 1 may be disposed below, adjacent to, and/or above subsurface material 140. Coarse filter material 170 may filter fluid entering system 1. Coarse filter material may comprise, but is not limited to, rock, stone, sand, silica, other granular material, or a combination thereof. Coarse filter material 170 may comprise a plurality of stones. The plurality of stones may comprise stones of a diameter of about ⅜″ to about 6″ (or other dimensions), and may be rounded, angular, another shape, or a combination thereof. Dewatering fabric 195 may be disposed above geocellular module 5. Dewatering fabric 195 may comprise a high mechanical strength and may be woven. In operation, dewatering fabric 195 may be configured to filter a portion of the fluid. Material and/or fluid may be disposed within dewatering fabric 195 through port 200 and filled, as shown by water level 205. Dewatering fabric 195 may be at least partially disposed above cover 15. In some embodiments, dewatering fabric 195 may comprise, but is not limited to, a polymer yarn. The polymer yarn may comprise, but is not limited to, polypropylene. The filtered fluid may contact geocellular module 5. A sand layer may be at least partially disposed between cover 15 and geocellular module 5. The sand may comprise, but is not limited to, coarse sand. The sand layer may comprise a height of about 0.5″ to about 24″, but other heights may be suitable depending on the application(s).

In some embodiments, one or more above ground treatment modules may be in communication with system 1. In operation, system 1 may be configured to pump a fluid at least partially disposed within the system cavity to one or more above ground treatment modules. In some embodiments, one of the above ground treatment modules may comprise fines and acid treatment module and organic treatment module 185. The system may be configured to apply a pH treatment at above organic treatment module 185 and perform an organic treatment at above ground treatment module 185. System 1 may in communication with organic treatment module 185 via conduit 180. System 1 may also be in communication with filtering and/or finishing module 190. Filtering and/or finishing module 190 may be configured to receive fluid from above ground treatment module 185 or directly from system 1. Discharge fluid may then be provided from filter and/or finishing module 190.

In some embodiments, system 1 may comprise a first fabric layer at least partially disposed beneath geocellular module 5. A geomembrane layer may be at least partially disposed beneath the first fabric layer and a second fabric layer may be at least partially disposed beneath the geomembrane layer.

FIG. 9 depicts an embodiment comprising one or more permanent and/or modular reclamation beds that may be used for solid and fluid processing. In this particular embodiment, a solid may be at least partially disposed within one or more portable holding devices. The portable holding devices may comprise dewatering fabric 195, which may comprise bags, sacks, or any other suitable container that may comprise, but is not limited to, dewatering containers, sewn material, woven material, fabric, membranes, nets, geotextiles, or a combination thereof. Suitable containers include, but are not limited to, any fillable dewatering container. Dewatering fabric 195 which may be at least partially disposed to be in communication with geocellular module 5. Port 200 may be in communication with dewatering fabric 195, which may allow for filling of dewatering fabric 195.

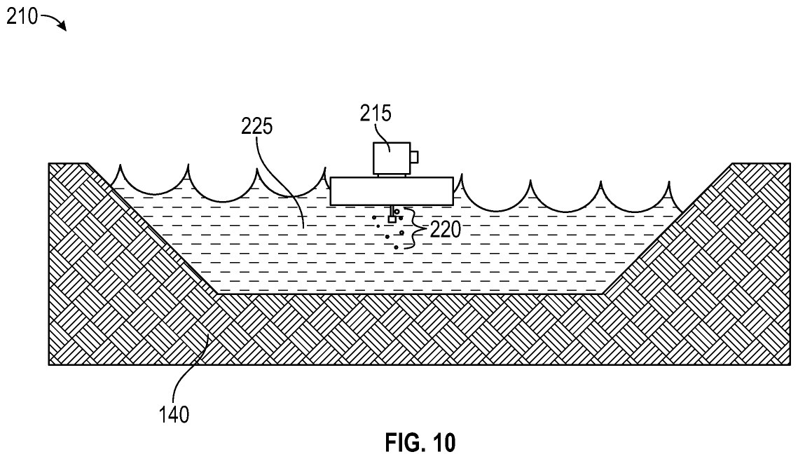

FIG. 10 is an embodiment showing fluid storage structure 210 containing fluid 225. Fluid storage structure 210 may comprise, but is not limited to, a tailings pond, decanted water pond, processed water pond, waste water pond, a ship or aircraft cargo, or a combination thereof. In some embodiments, floating aeration device 215 may be partially disposed within the fluid of the fluid storage structure. Floating aeration device 215 may provide fluid 225 fluid storage structure 210 with gas 220, including but not limited to, air, oxygen, carbon dioxide, nitrogen, a noble gas, or a combination thereof. Providing gas to the fluid may enhance evaporation of the fluid. Fluid storage structure 210 may be formed with subsurface material 140.

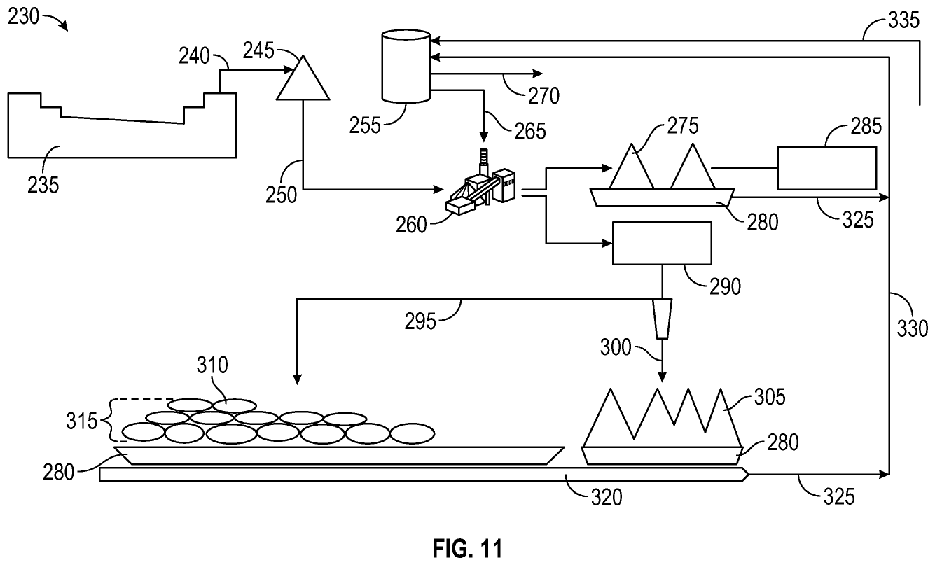

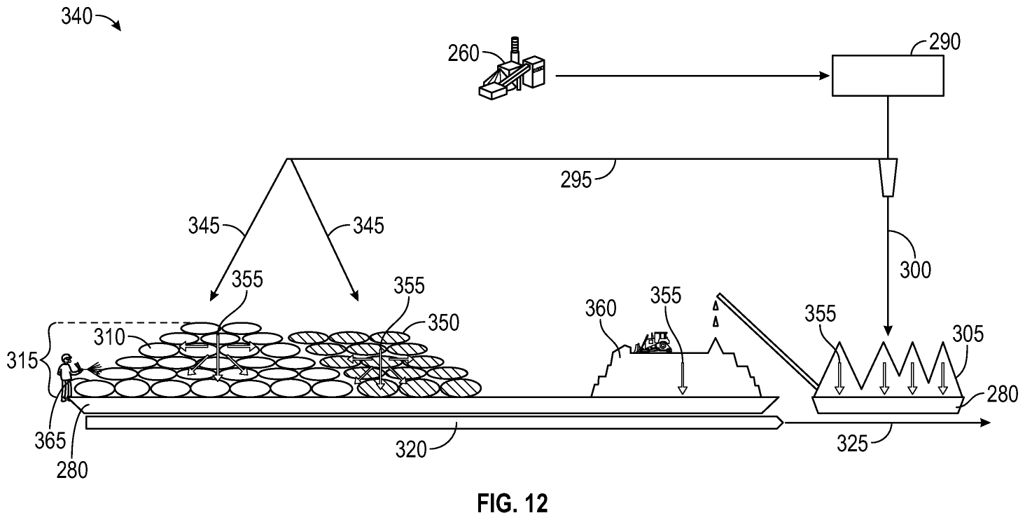

As shown in FIGS. 11-12, the system of the present invention may be used to collect fluid from mineral operations according to system 230. Ore 240 is extracted from mine 235 to form ore stockpile 245. Raw ore stream 250 is processed at mineral processing plant 260 using input fluid 265 stored in reservoir 255. Dust 270 is eluted from reservoir 255 to clarify input fluid 265 before it enters mineral processing plant 260. Product from mineral processing plant 260 is stored in heap 275 and is collected by system layer 280. System layer 280 comprises one or more systems of the present invention. System 230 of the present invention may include, but is not limited to, geocellular module 5. Drained product heap 275 is then formed into product to market 285. Fluid is collected by system layer 280 and is conveyed by conduit 325 to fluid flow 330. Conduit 325 may comprise fluid conveyors to collect and transport fluid. The fluid conveyors may comprise, but are not limited to, tubes, pipes, and/or perforated tubes and/or pipes. Mineral processing plant 260 may also produce waste product 290. Waste product 290 may comprise, but is not limited to, tailings, slurry, mineral agglomerates, or a combination thereof. Waste product 290 may be processed by, but not limited to, a mineral cyclone, heap, pile, mound, or a combination thereof. Fluid overflow 345 from waste product 290 may flow into dewatering bag tailings dam 315 comprising dewatering bag 310. Fluid underflow 300 from waste product 290 may flow into underflow sand 305. System layer 280 may collect fluid from dewatering bag 310 and underflow sand 305. Collected fluid flow 320 may be conveyed by conduit 325 to fluid flow 330. Fluid flow 330 may flow into reservoir 255. Additional fluid, for example, make-up water, may flow into system 335 as needed. Fluid may enter collected fluid flow 320 to be conveyed from system 230.

Referring to FIG. 12, system 340 shows additional embodiments of fluid collection from mineral operations using the system of the present invention. According to system 340, mineral processing plant 260 may provide input fluid for waste product 290. Fluid overflow 295 may comprise overflow slime 345. Fluid overflow 295 may flow into dewatering bag 310 and/or low strength and/or degradable watering bag 350. Dewatering bag 310 may be contacted with polymer coating 365. Low strength and/or degradable watering bag 350 may be in contact with the inner surface of dewatering bag tailings dam 315. Fluid underflow 300 may flow from waste product 290 into underflow sand 305. The mixture of fluid underflow 300 and underflow sand 305 may be transferred to a dry reclamation pile 360. Fluid in dewatering bag 310, low strength and/or degradable watering bag 350, underflow sand 305, reclamation pile 360, or a combination thereof, may proceed along flow 355. Flow 355 may comprise flows that are vertical, lateral, a mixture of vertical and lateral flows, or a combination thereof. For example, fluid may flow vertically downward, laterally across, or diagonally through dewatering bag 310. Fluid from dewatering bag 310, low strength and/or degradable watering bag 350, underflow sand 305, and reclamation pile 360, or a combination thereof, may be collected by system layer 280 and conveyed by conduit 325.

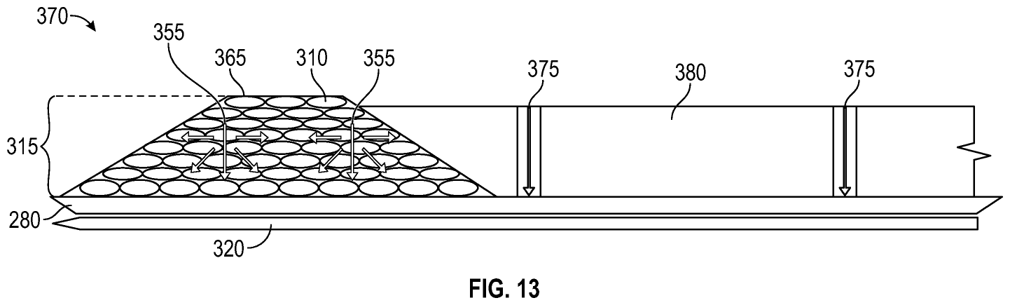

Turning now to FIG. 13, system 370 shows an embodiment of a tailings dam comprising the system of the present invention. Wet tailings 380 are held in place by dewatering bag tailings dam 315 comprising polymer coating 365, and dewatering bag 310. Fluid may flow through dewatering bag tailings dam 315 along flow 355. Fluid may flow through wet tailings 380 by entering water decant tower 375. Water decant tower 375 may be in communication with system layer 280. Fluid may enter collected fluid flow 320 to be conveyed from system 370.

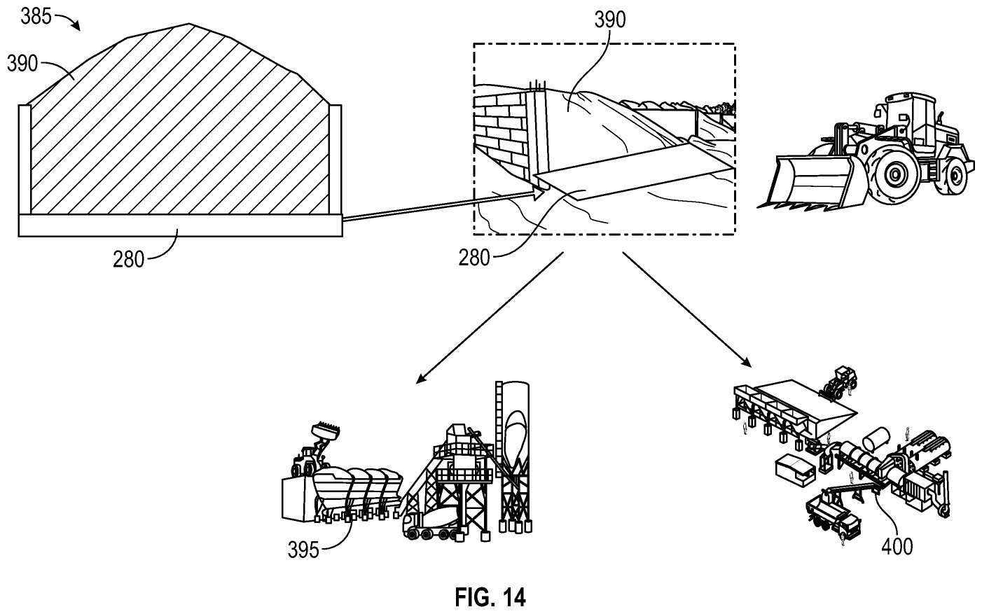

Referring now to FIG. 14, fluid from concrete and/or asphalt aggregates is collected according to the process shown in diagram 385. Concrete and/or asphalt aggregate 390 is at least partially disposed above or near system layer 280. System layer 280 may be at least partially disposed at the toe of a concrete and/or asphalt aggregate 390 pile. A drained concrete and/or asphalt aggregate pile may be used in concrete batch plant 395 or asphalt batch plant 400.

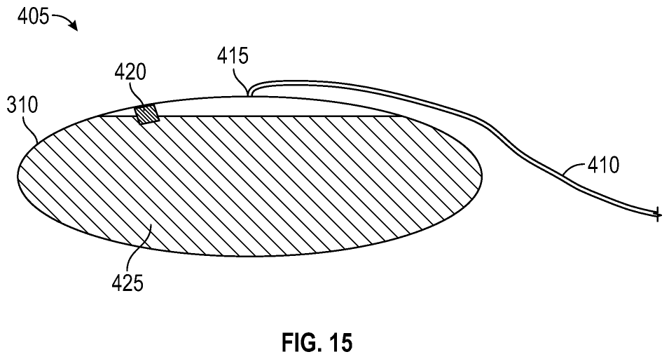

Referring now to FIG. 15, dewatering bag system 405 may comprise conduit 410, fill port 415, flocculant 420, and dewatering bag 310. Conduit 410 may comprise piping for conveying fluid including, but not limited to, mineral slurry, sand, soil, concrete mix, or a combination thereof. Fluid flows into dewatering bag 310 through fill port 415 and is contacted by flocculant 420. Flocculant 420 may be at least partially disposed within dewatering bag 310 and may be sewn into the seam of dewatering bag 310. The fluid contact fill 425, which is at least partially disposed within dewatering bag 310.

Embodiments of the present system may be utilized in conjunction with a wide variety of possible applications. Some of these may include, but are not limited to, industrial sand, glass sand, foundry sands, frac sand, concrete sand, iron ore/slag, potash, coal stockpiles, crushed aggregates, biomass heaps, fertilizer heaps, dry/bulk storage facilities, transload facilities, wood pulp processing and storage, heap leach processing, salt processing, agriculture silos, rail transload facilities, industrial washing bays, etc. Embodiments of the present disclosure may also be used to collect and hold fluid in a seafaring vessel, e.g., a cargo ship, cruise ship, or aircraft carrier, etc., using the principles set forth in this invention and in the drawings.

In some embodiments, the system may be modified into a mobile application to work remotely around tailings ponds for dewatering purposes. The tailings byproducts may then dry into a solid/cake and be properly disposed of or further processed into usable materials. Removal of tailings byproducts may assist with mining reclamation activities.

The system may be used to collect fluid from different structures. The system may collect the underflow and/or overflow fluid from mining/mineral tailings. The system may be at least partially disposed beneath mining/mineral tailings and/or disposed around the perimeter of mining/mineral tailings. The system may also be used to collect water seepage from slopes, landslides, embankments, dams, dikes, levees, and underground applications. The system may be used to convey seepage flow from a dam to prevent dam damage or erosion. The system may be at least partially disposed at the toe of the dam and/or beneath the dam. The system may be at least partially disposed beneath and/or around the perimeter of or close to a dry stack or wet stack of mining/mineral processing tailings. The system may collect fluid from underground mines, water reserves, caverns, tunnels, railway systems, shelters, or a combination thereof.

The system may be part of new construction at a facility, or retrofitted to an existing facility.

The system may be used to extract fluid from oil production sites. Fluid from oil production, e.g., a water and oil mixture, may be at least partially disposed into the system cavity. The fluid may be conveyed to a lift station, fluid storage tank, separation tank, acid treatment module, organic treatment module, filtering and/or finishing module, or a combination thereof. The cavity, lift station, fluid storage tank separation tank, acid treatment module, organic treatment module, filtering and/or finishing module, or a combination thereof may be at least partially disposed at a higher elevation than a transport vehicle to allow the transport vehicle to receive the fluid by gravity. The transport vehicle may be a truck, train, aircraft, watercraft, or any other vehicle capable of conveying fluid.

The system may be used to manage fluid processing including, but not limited to, draining, capturing, evaporating, conveying, lifting, filtering, treating, separating, and aerating fluid. Fluid may be used after processing or recycled back in a closed loop.

Embodiments included herein are directed towards drainage or fluid collection systems. The system may be disposed at grade differential or gradient. A grade differential may be the degree angle relative to a flat plane. For example, a grade differential means a five degree difference, i.e., a slope, compared to a flat plane. The grade differential may convey fluid across the system cavity. The grade differential may be at least about 1 degree, about 1 degree to about 10 degrees, about 2 degrees to about 8 degrees, about 4 degrees to about 6 degrees, or about 10 degrees of slope. The grade differential may also be about 1.19 degree of slope. The system may comprise a valve to control fluid flow through the cavity. The fluid may be conveyed by gravity.

The system of the present invention may comprise a liner. The liner may preferably comprise a geomembrane liner and/or a polymer. The polymer may comprise, but not be limited to, elastomer, a thermoplastic polymer, a plastic polymer, or a combination thereof. The elastomer may comprise, but not be limited to, diene, non-diene, and thermoplastic elastomers. The polymer may comprise, but not be limited to, polyurea, polyethylene, high-density polyethylene, acrylic rubber, acrylic ethylene rubber, acrylonitrile butadiene, butadiene rubber, bromobutyl, butyl rubber, chlorobutyl, chloropolyethylene, chloroprene rubber, chlorosulfonated ethylene, elastomers, epichlorohydrin rubber, epoxyprene, ethylene-propylene-diene, ethylene-vinyl-acetate, fluoroethylene propylene, perfluoroelastomers, chlorosulfonated polyethylene, hydrogenated nitrile, isoprene rubber, nitrile rubber, natural rubber, neoprene, polybutadiene, polynorbornene, polythioethers, silicone rubber, styrene-butadien, sirenic copolymers, tetrafluoroethylene propylene, polysulfides, urethane, vinyl methyl silicone, fluoroelastomers, or a combination thereof. The liner may comprise a thickness of at least about 10 mm, about 10 mm to about 120 mm, about 20 mm to about 110 mm, about 30 mm to about 100 mm, about 40 mm to about 90 mm, about 50 mm to about 80 mm, about 60 mm to about 70 mm, or about 120 mm. The liner may be at least partially disposed around the cavity. The system may also comprise a geocellular module configured to provide structural support. The geocellular module may comprise, but not be limited to, a thermoplastic polymer. The thermoplastic polymer may comprise polyolefins. The thermoplastic polymer may comprise, but not be limited to, polypropylene, polyethylene, polyvinyl chloride, thermoplastic polyimide, polyaryletherketone, self-reinforced polyphenylene, polyphenylene sulfide, polyamideimide, polyarylate, poly(ether)sulfone, polyoxymethylene, or a combination thereof. The system may comprise a liner comprising one or more smooth sides. The liner sides may be manufactured.

The geocellular module may comprise at least one hollow chamber to increase its surface area and/or surface area to volume ratio. The geocellular module may comprise a heat and/or chemical resistant material. The geocellular module may comprise, but not be limited to, a hydrophobic, impermeable, or water-resistant material. The geocellular module may comprise a non-reactive material. The non-reactive material may be a material that does not substantially or at all degrade, disintegrate, weaken, soften, flake, crack, become brittle, or become physically or chemically altered on initial contact with a chemical reagent, or for a short period after. The short period may be up to one year of constant or intermittent contact with the reagent. The chemical reagents may include, but are not limited to, chemical reagents that are caustic, acidic, corrosive, adhesive; chemical reagents that act as organic solvents, oxidizers, reducers, or electron transports; chemical reagents that are dyes, colorants, or cause luminescence; or reagents that sorb onto a surface. The geocellular module may comprise recycled materials and may be recyclable. The geocellular module may comprise food grade plastic, virgin, i.e., unrecycled, plastic material, or a combination thereof.

The geocellular module may comprise a high pressure resistance material. The geocellular module may comprise a high mechanical strength. The geocellular module may comprise a compressive strength of at least about 200 kN/m², about 200 kN/m² to about 1,200 kN/m², about 250 kN/m² to about 1,150 kN/m², about 300 kN/m² to about 1,100 kN/m², about 350 kN/m² to about 1,050 kN/m², about 400 kN/m² to about 1,000 kN/m², about 450 kN/m² to about 950 kN/m², about 500 kN/m² to about 900 kN/m², about 550 kN/m² to about 850 kN/m², about 600 kN/m² to about 800 kN/m², about 650 kN/m² to about 700 kN/m², or about 1,200 kN/m². The geocellular module may comprise a lateral strength of at least about 50 kN/m², about 50 kN/m² to about 150 kN/m², about 70 kN/m² to about 130 kN/m², about 90 kN/m² to about 110 kN/m², or about 150 kN/m². The geocellular module may comprise a load bearing capacity of at least about 30 tons, about 30 tons to about 110 tons, about 40 tons to about 100 tons, about 50 tons to about 90 tons, about 60 tons to about 80 tons, or about 110 tons.

The geocellular module may comprise a base plate, an end plate, and a spacer column. The geocellular module may comprise a first base plate and a second base plate with at least one spacer column at least partially disposed between the first base plate and second base plate. The geocellular module may also comprise at least one end plate at least partially disposed between the first base plate and the second base plate. In one embodiment, at least one spacer column and four end plates are disposed between the first base plate and second base plate to form a rectangular or square shaped geocellular module. The spacer column may comprise a cylindrical, rectangular prism, triangular, any other shape, or a combination thereof.

The system may comprise a storage availability at least one layer of geocellular module. The system may comprise any number of geocellular module layers. The system may comprise one geocellular module layer to 14 geocellular module layers. Each geocellular module layer may be at least about 2 inches, about 2 inches to about 48 inches, about 4 inches to about 44 inches, about 6 inches to about 36 inches, about 8 inches to about 32 inches, about 10 inches to about 28 inches, about 12 inches to about 24 inches, about 16 inches to about 20 inches, about 48 inches in height, or other suitable height depending on the application. Each geocellular module layer may be accessed and visually inspected post construction. The geocellular modules may comprise a variable height. Geocellular modules with variable height may prevent fluid velocity from being reduced or restricted. A geocellular module may be of any height and width. The geocellular module may also have a cubed, rectangular, rounded, or other shape. Geocellular modules may be interconnected, modular, and combined to form a larger unit.

In some embodiments, the systems and processes described herein provide underground moisture infiltration/recovery capabilities, one or more storage cavities, artificial lift techniques, filtering processes, enhanced evaporation from mechanical aeration, etc. Embodiments included herein may provide for complete management of processed mine/production water as well as an environmental best management practice along with being an engineered process efficiency device. This system may prevent off-site water discharge along with groundwater contamination. Embodiments included herein allow for the system to be accessed after installation via inspection shafts and hatches and may also comprise a rinse/wash system to periodically clean and have the ability to vacuum out the system cavity. This system may comprise structural components to allow mine equipment, e.g., up to 200,000 lbs., to travel simultaneously with stacked products. This system may be heated for cold climate use.

In operation, material may be stacked and/or piled up into heaps from a radial stacker or inline overhead tripper stacker. An area of stacked material may be excavated to a certain depth (e.g., 6′ by x area) to form a cavity. Lining of the cavity may be performed with a coated fabric. The fabric may comprise, but not be limited to, a polymer, sand, bitumen, glass, or a combination thereof. The polymer may comprise, but not be limited to, polyurea, high-density polyethylene, or a combination thereof. Installation and building of the geocellular module may create the void space and/or holding space for the collected fluid. Outlets and conduits, e.g., piping and spray nozzles, may be installed and hangered to create an internal wash system and plumbed surface for wash connection ports. Ports may be included with hatches for access of inspection and air flow to the storage area created by the geocellular module. The ports create a negative pressure zone. Lateral conduits, e.g., SDR-11 and/or HDPE pipes, may communicate with the lift station as needed. The lift station accommodates for discharge challenges where fluid flow by gravity may be impeded and an artificial lift is needed to further convey fluid.

The wash system may be interlaced into the geocellular module. Spray heads may be used to move or wash sediment of the geocellular module. Aerators may be used to accelerate fluid evaporation and remediation by dissolved gas into the fluid. The gas may comprise oxygen.

The systems and methods included herein may comprise cavities and geocellular membranes that form at least about 20%, about 20% to about 97%, about 30% to about 95%, about 40% to about 90%, about 50% to about 80%, about 60% to about 70%, or about 97% void space within the cavity. Depending on materials and applications, other void spaces may be provided.

The system of the present invention may comprise a non-motorized holding and capture system. The system may lift, filter, drain, and/or evaporate excess tailings water. The lifting, filtering, draining, and/or evaporation may be active and may be accelerated by the system compared to other processes.

The system may further comprise a capacity to store fluid underground. Using a plurality of geocellular modules across the surface area of the drain field may equate to hundreds to millions of gallons of fluid storage.

In some embodiments, the system may comprise one or more lift stations to correct inverted elevation where fluid must be artificially lifted with pumps against the force of gravity. The system may also comprise an interlocking cover. The cover may also comprise, but not be limited to, a non-thermal expansive and/or reactive cover.

The system may comprise a smooth floor. The smooth floor may comprise, but not be limited to, a non-woven polyester, a geotextile, bitumen, sand, glass, a polymer, isocyanate, resin, fabric, or a combination thereof. The polymer may comprise, but not be limited to, a high density polyethylene, polyurea, or a combination thereof. The smooth floor may be elastic. The floor may comprise a non-stick bottom. The non-stick bottom may comprise surface projections to remove or limit lateral movement in the geocellular modules. The surface projections may be about 16 mm to about 22 mm, but other configurations may be suitable, depending on the application.

The system may comprise a sub-drain that may be at least partially disposed beneath the liner especially when the liner is impermeable. The sub-drain may mitigate shallow water or subsurface springs that can force the system up by heaving. The sub-drain may be horizontally or vertically standing. The sub-drain may be a dual sided collector and may convey the collected ground water to a release point or additional lift station for evacuation. The sub-drain may comprise a width of about 9″ to about 12″ and may comprise a vertical length of about 10′ to about 100′, although other widths and lengths may be suitable, depending on the application. The sub-drain may be formed or shaped freely as needed. Each sub-drain run length may be interconnected and has the ability to be multi-coupled with one or more additional sub-drains.

The system may comprise a cavity comprising a square or rectangular perimeter. The cavity may also comprise a curved or radial shape.

The system may comprise structural side walls; vent and/or not-vented hatch covers; remote access units with and without extension shafts; permeable cavity covers; an internal washing system in communication with a water source, e.g., water trucks, water tanks, water reservoirs, water containers, etc.; a geocellular module; and vertical mounts and/or with spray nozzles to rinse and/or wash the geocellular module.

The system may comprise an air void space when the cavity and the geocellular module are empty. The air void space may be about 20% to about 97% by volume. The air void space may create a large pressure zone. In the present disclosure, as inflow of fluid fills the air void space in the cavity and the geocellular module. The air void space may then be diminished proportionately to fluid volume. Conversely, water levels decrease in volume when air void space increases. The large pressure zone forces fluid out of the cavity and the geocellular module. A positive air pressure may be introduced into the cavity by one or more vertical access points. Negative air pressure may be introduced as fluid exits the cavity.

The system may comprise above ground vent stations for ambient air and vault storage air pressure exchanges to occur. This eliminates back flow or stagnation of fluid velocity through the system. Air pressure exchange between the above ground ambient air and system cavity enhances fluid collection and flow.

The system may incorporate a method for preventing filter cake formation. Solid particles deposited on a filter layer are referred to or known as the “filter cake”. In filtration, solid particles may be separated from a fluid-solid mixture by forcing fluid through a filter medium or cloth (in this case, the force is pile head pressure). Filters, e.g., monofilament woven fabrics, may be precisely manufactured via wash water analysis and permeability testing in bucket trials to optimize filter pore size. Optimizing filter pore size prevents and/or mitigates the formation of a filter cake.

The system may comprise an in-ground “excavated” capture and hold design. The system may minimize lined surface storage water ponds and above ground storage tanks by comprising an air void space of preferably about 95% of the cavity, although a lower void space can also be effective.

In some embodiments, the system may allow for cold climate mining. Ice in the system's cavity may be thawed by heated air from a heater. The system may allow for operation in temperatures in cold or hot climates.

The system may raise fluid from a lower elevation to a higher elevation via a lift station. The lift station may comprise a pump to raise fluid to a higher elevation.

The cover may be assembled using a hand turn tool. The hand turn tool may comprise a cam hand turn tool. The system may operate without material at least partially disposed above the top of the system.

The system may comprise processes to manage and process fluid for fines, ultra-fines, and/or total suspended solids for reuse to the operator's wash plant or additional onsite storage or to discharge tailings ponds. The system may use one or more aeration units to accelerate the process of evaporation in holding and/or tailings ponds.

The system of the present invention may comprise the ability to perform wash plan water testing prior to all drain builds. The water sampling may be sent to a chemical company for analysis of results for polymer dosing and effectiveness. The water sampling test may comprise any groundwater discharge test, evaporation test, e.g. a bucket test, water transmissivity test; any other water sampling test known to a person skilled in the art; or a combination thereof. This may help to show if the system operator is correctly processing fluid.

The system may be in communication with fluid conveyors to collect and transport fluid. The fluid conveyors may comprise tubes and/or pipes. The tubes and/or pipes may be perforated and may comprise diameters of at least about ⅛″, about ⅛″ to about ⅞″, about 2/8″ to about 6/8″, about ⅜″ to about ⅝″, or about ⅞″.

The system of the present invention may be in communication with one or more dewatering bags. The system may receive fluid from the dewatering bag. The dewatering bag may comprise, but not be limited to, a geotextile, fabric, paper, woven material, polymer strands, or a combination thereof. The dewatering bag may comprise a wide width tensile strength of at least about 50 kN/m, about 50 kN/m to about 140 kN/m, about 60 kN/m to about 130 kN/m, about 70 kN/m to about 120 kN/m, about 80 kN/m to about 110 kN/m, or about 140 kN/m. The dewatering bag may comprise a wide width tensile elongation of at least about 10%, about 10% to about 30%, about 15% to about 25%, or about 30%. The dewatering bag may comprise a seam strength of at least about 50 kN/m, about 50 kN/m to about 100 kN/m, about 55 kN/m to about 90 kN/m, about 60 kN/m to about 85 kN/m, about 70 kN/m to about 80 kN/m, or about 100 kN/m. The dewatering bag may comprise a puncture strength of at least about 5,000 N, about 5,000 N to about 12,000 N, about 6,000 N to about 11,000 N, about 7,000 N to about 10,000 N, about 8,000 N to about 9,000 N, or about 12,000 N.

The dewatering bag may comprise an apparent opening size of at least about 0.20 mm, about 0.20 mm to about 0.60 mm, about 0.25 mm to about 0.55 mm, about 0.30 mm to about 0.50 mm, about 0.35 mm to about 0.45 mm, or about 0.60 mm. The dewatering bag may comprise an O₅₀ pore size distribution of at least about 90 μm, about 90 μm to about 170 μm, about 100 μm to about 160 μm, about 110 μm to about 150 μm, about 120 μm to about 140 μm, or about 170 μm. The dewatering bag may comprise an O₉₅ pore size distribution of at least about 250 μm, about 250 μm to about 390 μm, about 270 μm to about 370 μm, about 290 μm to about 350 μm, about 310 μm to about 330 μm, or about 390 μm.

The dewatering bag may comprise a water flow rate through the surface of at least about 400 l/min/m², about 400 l/min/m² to about 5,200 l/min/m², about 800 l/min/m² to about 4,800 l/min/m², about 1,200 l/min/m² to about 4,400 l/min/m², about 1,600 l/min/m² to about 4,000 l/min/m², about 2,000 l/min/m² to about 3,600 l/min/m², about 2,400 l/min/m² to about 3,200 l/min/m², or about 5,200 l/min/m². The dewatering bag may comprise a UV resistance strength of at least about 65%, about 65% to about 99%, about 70% to about 97%, about 75% to about 95%, about 80% to about 90%, or about 97%. The dewatering bag UV resistance strength may be retained for at least about 400 hrs, about 400 hrs to about 1,000 hrs, about 500 hrs to about 900 hrs, about 600 hrs to about 800 hrs, or about 1,000 hrs. The dewatering bag may comprise a mass per unit area of at least about 350 g/m², about 350 g/m² to about 800 g/m², about 400 g/m² to about 750 g/m², about 450 g/m² to about 700 g/m², about 500 g/m² to about 650 g/m², about 550 g/m² to about 600 g/m², or about 800 g/m². The dewatering bag may comprise a thickness of at least about 0.4 mm, about 0.4 mm to about 3.0 mm, about 0.6 mm to about 2.8 mm, about 0.8 mm to about 2.6 mm, about 1.0 mm to about 2.4 mm, about 1.2 mm to about 2.2 mm, about 1.4 mm to about 2.0 mm, about 1.6 mm to about 1.8 mm, or about 3.0 mm.

The dewatering bag may comprise a fill capacity of at least about 60%, about 60% to about 95%, about 70% to about 90%, or about 95%. The dewatering bag may comprise a hauling capacity of at least about 8 tons, about 8 tons to about 20 tons, about 10 tons to about 18 tons, about 12 tons to about 16 tons, or about 20 tons. The dewatering bag may comprise a length of at least about 2 m, about 2 m to about 160 m, about 5 m to about 140 m, about 20 m to about 120 m, about 40 to about 100 m, 60 m to about 80 m, or about 160 m. The dewatering bag may comprise a wide of at least about 2 m, about 2 m to about 10 m, about 4 m to about 8 m, or about 10 m. When filled, the dewatering bag may comprise a circumference of at least about 5 m, about 5 m to about 30 m, about 10 m to about 25 m, about 15 m to about 20 m, or about 30 m. The dewatering bag may comprise a circumferential seam and a filled height of at least about 1 m, about 1 m to about 3.5 m, about 1.5 m to about 3.0 m, about 2.0 m to about 2.5 m, or about 3.5 m. Other capacities or dimensions may also be suitable, depending on the application(s).

The dewatering bag may comprise a tensile modulus at about 2% strain, as shown by a typical roll value, of at least 1,000 kN/m, about 1,000 kN/m to about 2,000 kN/m, about 1,100 kN/m to about 1,900 kN/m, about 1,200 kN/m to about 1,800 kN/m, about 1,300 kN/m to about 1,700 kN/m, about 1,400 kN/m to about 1,600 kN/m, or about 2,000 kN/m. The dewatering bag may comprise a tensile modulus at about 5% strain, as shown by a typical roll value, of at least 1,000 kN/m, about 1,000 kN/m to about 2,000 kN/m, about 1,100 kN/m to about 1,900 kN/m, about 1,200 kN/m to about 1,800 kN/m, about 1,300 kN/m to about 1,700 kN/m, about 1,400 kN/m to about 1,600 kN/m, or about 2,000 kN/m. Other tensile module strains may also be suitable, depending on the application(s).

A flocculant may be at partially disposed within the present system and/or the dewatering bag. The flocculant may be at least partially disposed within the geocellular module of the present system. The flocculant may be in a solid, liquid, or gas state. Solid flocculant may be sewn into the lining of a dewatering bag. The flocculant may be contacted with fluid at least partially disposed within a tailings pond, dewatering bag, fluid collection system, or a combination thereof. The flocculant may be organic, inorganic, ionic, and/or nonionic. The flocculant may comprise, but not be limited to, a bio-polymer, silicate ions, sodium silicate, colloidal silica, H₃SiO⁴⁻, polyacrylamide, carboxymethyl cellulose, polyanionic cellulose, polyelectrolytes, including but not limited to, polysaccharides, cationic starch, chitosan, chitosan acetate, and poly-γ-glutamic acid, functionalized nanoparticles, nanocellulose, tannin-based flocculants, aluminum sulfate, aluminum chloride, sodium aluminate, ferric sulfate, ferrous sulfate, ferric chloride, ferric chloride sulfate, hydrated lime, magnesium carbonate, aluminum chlorohydrate, polyaluminum chloride, polyaluminum sulfate chloride, polyaluminum silicate chloride, polyferric sulfate, ferric salts, diallydimethyl ammonium chloride, or a combination thereof.

The dewatering bag may be used to form or retrofit a tailings dam. The tailings dam may comprise at least two layers of dewatering bags. A plurality of dewatering bags may be arranged in a stacked or pyramidal configuration, wherein an upper layer comprises a smaller number of dewatering bags than a lower layer at least partially disposed beneath the upper layer. The tailings dam may comprise a conduit in communication with the dewatering bag. The conduit may be connected to the dewatering bag by a port attached to the dewatering bag. The layers of dewatering bags may be offset from one another such that at least a portion of a dewatering bag in a lower layer extends past the edge of a dewatering bag in an upper layer. The tailings dam may comprise an inner surface. The inner surface may be in contact with the tailings and/or low strength and/or degradable dewatering bags and the inner surface may comprise a plurality of dewatering bags. The tailings dam may comprise an outer surface in contact with the atmosphere and the outer surface may comprise a plurality of dewatering bags. The outer surface may be coated and/or sealed with a polymer. The coating and/or sealant may prevent fluid from flowing out of the outer surface. The coating and/or sealant may comprise a polymer, including, but not limited to, polyurethane; polyethylene; polystyrene; clay, including, but not limited to, bentonite, montmorillonite, kaolinite, or a combination thereof; rubber; or a combination thereof. The tailings dam may also comprise a low strength and/or degradable bag to receive fluid before the fluid flows into the dewatering bag. The tailings dam may impound and/or hold in place wet tailings. Fluid may flow through the wet tailings by entering a water decant tower or other dewatering apparatus. The water decant tower may convey fluid to a drainage collection system.

Fluid may be flowed through the tailings dam comprising the dewatering bag. Fluid may be flowed laterally and vertically through the dewatering bag of the tailings dam. The fluid may be pumped through the dewatering bag and/or flowed through the dewatering bag by gravity. The tailings dam may be at least partially disposed above, or in proximity to, a system of the present invention. Fluid from the dewatering bag of the tailings dam may flow into the system of the present invention.

The system of the present invention may be used to collect fluid from concrete and/or asphalt aggregate. The concrete and/or asphalt aggregate may comprise geological or natural materials including, but not limited to, gravel, sand, crushed rock, or a combination thereof. Fluid collection from the concrete and/or asphalt aggregate may keep the concrete aggregate at a saturated surface dry condition or lower material moisture contents for asphalt aggregate and/or asphalt production. Fluid from concrete and/or asphalt aggregate may be required to be captured and/or not permitted to run off production sites by law or according to an environmental plan.

Note that in the specification, “about” or “approximately” means within twenty percent (20%) of the amount or value given.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents are intended to include any structure, material, or act for performing the function in combination with other elements. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A system for collecting fluid, the system comprising:
a geocellular module;
a liner below and at least partially disposed around said geocellular module;
a filter disposed above said geocellular module;
a cover disposed above said geocellular module; and
said system disposed at a gradient.

2. The system of claim 1 further comprising a drainage board.

3. The system of claim 1 further comprising an internal washing system.

4. The system of claim 1 further comprising a subdrain.

5. The system of claim 1 further comprising a separation tank.

6. The system of claim 1 wherein said geocellular module comprises a non-reactive material.

7. The system of claim 1 wherein said liner comprises a geomembrane liner.

8. The system of claim 1 further comprising a lift station.

9. The system of claim 1 further comprising an aerator.

10. The system of claim 1 wherein said cover is modular.

11. The system of claim 1 wherein said system comprises a void space of about 20% to about 97%.

12. The system of claim 1 further comprising at least one dewatering bag at least partially disposed above said geocellular module.

13. The system of claim 12 wherein said dewatering bag comprises a coating.

14. The system of claim 12 wherein said dewatering bag comprises a flocculant.

15. A method for collecting fluid, the method comprising:
passing a fluid through a cover;
receiving the fluid into a cavity;
contacting the fluid with a geocellular membrane;
contacting the fluid with a geomembrane liner;
flowing the fluid along a gradient; and
collecting the fluid.

16. The method of claim 15 further comprising passing the fluid into a separation tank.

17. The method of claim 15 further comprising aerating the fluid.

18. A tailings system comprising:
a fluid collection system comprising:
a geocellular module;
a liner below and at least partially disposed around said module;
a filter disposed above said geocellular module;
a cover disposed above said geocellular module; and
said system disposed at a gradient;
at least one dewatering bag;
said least one dewatering bag at least partially disposed above said fluid collection system; and
a conduit in communication with said at least one dewatering bag.

19. The system of claim 18 wherein said at least one dewatering bag comprises a coating.

20. The system of claim 18 further comprising a plurality of dewatering bags arranged in a stacked or pyramidal configuration.
